(19) United States
(12) Patent Application Publication
(10) Pub. No.: US 2026/0223254 A1
(43) Pub. Date: Jul. 30, 2026

(54) CERAMIC HEATER, CERAMIC HEATER MODULE, LIQUID HEATING DEVICE, AND METHOD FOR MANUFACTURING CERAMIC HEATER

(71) Applicant: NITERRA CO, LTD., Nagoya-shi (JP)

(72) Inventors: Hiroki HATTORI, Nagoya-shi (JP); Kazuki TANIZAWA, Nagoya-shi (JP)

(73) Assignee: NITERRA CO, LTD., Nagoya-shi (JP)

(21) Appl. No.: 19/456,429

(22) Filed: Jan. 22, 2026

(30) Foreign Application Priority Data
Jan. 29, 2025 (JP) 2025-013251

(51) Int. Cl. H05B 3/28; H05B 3/46

(52) U.S. Cl. CPC H05B 3/283; H05B 3/46; H05B 2203/017; H05B 2203/021

(57) ABSTRACT

A ceramic heater includes a tubular ceramic body having a first opening through which a medium can flow thereinto, at one end thereof, and a second opening through which the medium can flow out therefrom, at another end thereof; and a first resistive heating element provided on at least a part of an inner circumferential surface of the ceramic body and configured to generate heat when being energized.

### TECHNICAL FIELD

The present disclosure relates to a ceramic heater, a ceramic heater module, a liquid heating device, and a method for manufacturing a ceramic heater.

### BACKGROUND ART

Conventionally, a ceramic heater has been known as a heater for controlling the heating of a medium (see, for example, Patent Document 1).

The ceramic heater has a tubular ceramic base body having a resistive heating element embedded therein, and the medium can flow on the surface (the inner circumferential surface and the outer circumferential surface) of the ceramic base body. The heat generated in the resistive heating element when the resistive heating element is energized is conducted through the ceramic base body and exchanged with the medium flowing on the surface of the ceramic base body. Accordingly, the medium is heated.

### PRIOR ART DOCUMENT

### Patent Document

[Patent Document 1] Japanese Patent Application Laid-Open (kokai) No. 2017-4915

### Summary of the Invention

### PROBLEMS TO BE SOLVED BY THE INVENTION

In the conventional ceramic heater, the resistive heating element is embedded on the radially outer side of the ceramic base body. With this configuration, the heat generated in the resistive heating element is more easily conducted to the outer circumferential surface of the ceramic base body than to the inner circumferential surface of the ceramic base body. Therefore, the medium is more easily heated during the period when the medium flows on the outer circumferential surface of the ceramic base body than during the period when the medium flows on the inner circumferential surface of the ceramic base body. Such a ceramic heater has room for improvement in terms of thermal efficiency.

The present invention has been made to address the above-described problem. That is, one object of the present invention is to provide a technology capable of improving the thermal efficiency of a ceramic heater.

### Means for Solving the Problems

A ceramic heater (20) according to the present invention includes:
a tubular ceramic body (51) having a first opening (O1) through which a medium can flow thereinto, at one end thereof, and a second opening (O2) through which the medium can flow out therefrom, at another end thereof; and
a first resistive heating element (62) provided on at least a part of an inner circumferential surface of the ceramic body and configured to generate heat when being energized.

### Effects of the Invention

In the ceramic heater according to the present invention, the first resistive heating element is provided on the inner circumferential surface of the ceramic body. With this configuration, the heat generated in the first resistive heating element is more easily conducted to the inner circumferential surface of the ceramic body than to the outer circumferential surface of the ceramic body. Therefore, from the viewpoint of temperature rise of the medium by the first resistive heating element, the medium is more easily heated during the period when the medium flows on the inner circumferential surface of the ceramic body than during the period when the medium flows on the outer circumferential surface of the ceramic body. Here, in general, in a tubular heating element, the thermal efficiency for heating a medium flowing on the inner circumferential surface of the heating element is higher than the thermal efficiency for heating the medium flowing on the outer circumferential surface of the heating element. Therefore, the ceramic heater according to the present invention can improve thermal efficiency compared to a configuration in which the first resistive heating element is provided on the outer circumferential surface of the ceramic body.

In one aspect of the present invention,
the ceramic heater (20) further includes a first ceramic layer (52) covering a surface of the first resistive heating element (62).

With this configuration, since the surface of the first resistive heating element is covered with the first ceramic layer, the durability of the first resistive heating element can be enhanced.

In one aspect of the present invention,
the ceramic heater (20) further includes a second resistive heating element (63) provided on at least a part of an outer circumferential surface of the ceramic body (51) and configured to generate heat when being energized.

In the ceramic heater, the second resistive heating element is further provided on the outer circumferential surface of the ceramic body. With this configuration, by appropriately setting the connection configuration between the first resistive heating element and the second resistive heating element, thermal efficiency can be improved, and the possibility of the medium boiling can be significantly reduced when the medium is liquid. Here, the above connection configuration typically means a parallel connection. To describe the effect of the parallel connection, a ceramic heater in which only a third resistive heating element is provided on the outer circumferential surface of the ceramic body is described as a conventional example. If the resistance value of the third resistive heating element is matched with the combined resistance value of the first and second resistive heating elements and the same voltage is applied to both ceramic heaters, while the power generated in both ceramic heaters is the same, the power in each of the first and second resistive heating elements can be reduced compared to the power in the third resistive heating element (for example, if each of the resistance values of the first and second resistive heating elements is set to 2R and the resistance value of the third resistive heating element is set to R, the power in each of the first and second resistive heating elements is one-half of the power in the third resistive heating element). With this configuration, in the ceramic heater according to the conventional example, the medium is not heated much during the period when the medium flows on the inner circumferential surface of the ceramic body, and is heated rapidly by the heat in the third resistive heating element during the period when the medium flows on the outer circumferential surface of the ceramic body. In contrast, in the ceramic heater according to the one aspect of the present invention, the medium is slowly heated mainly by the heat in the first resistive heating element during the period when the medium flows on the inner circumferential surface of the ceramic body, and the medium is slowly heated mainly by the heat in the second resistive heating element during the period when the medium flows on the outer circumferential surface of the ceramic body. That is, in the one aspect of the present invention, compared to the conventional example, it is possible to lower the power density (energy density per unit time) of the ceramic body. Therefore, a situation where the liquid medium is rapidly heated is less likely to occur, and the possibility of the liquid medium boiling can be significantly reduced, resulting in suppressing the occurrence of ceramic heater breakage due to boiling.

In one aspect of the present invention,
the ceramic heater (20) further includes a second ceramic layer (53) covering a surface of the second resistive heating element (63).

With this configuration, since the surface of the second resistive heating element is covered with the second ceramic layer, the durability of the second resistive heating element can be enhanced.

In one aspect of the present invention,
the first ceramic layer (52) has a radial thickness of 0.1 mm or more and 1.0 mm or less.

When the radial thickness of the first ceramic layer is set to 0.1 mm or more, the strength of the first ceramic layer can be ensured. Also, when the radial thickness of the first ceramic layer is set to 1.0 mm or less, the conductivity of the heat generated in the first resistive heating element can be suitably maintained.

In one aspect of the present invention,
the second ceramic layer (53) has a radial thickness of 0.1 mm or more and 1.0 mm or less.

When the radial thickness of the first ceramic layer is set to 0.1 mm or more, the strength of the first ceramic layer can be ensured. Also, when the radial thickness of the first ceramic layer is set to 1.0 mm or less, the conductivity of the heat generated in the first resistive heating element can be suitably maintained. In addition, when the radial thickness of the second ceramic layer is set to 0.1 mm or more, the strength of the second ceramic layer can be ensured. Also, when the radial thickness of the second ceramic layer is set to 1.0 mm or less, the conductivity of the heat generated in the second resistive heating element can be suitably maintained.

In one aspect of the present invention,
the medium is a liquid medium, and
the ceramic heater (20) is used as an in-vehicle heat exchanger.

With this configuration, an in-vehicle heat exchanger in which the thermal efficiency of the ceramic heater is improved can be provided.

A ceramic heater module (1) according to the present invention includes:
the ceramic heater (20) according to the present invention; and
a case (10) housing the ceramic heater therein and having an inlet (11) and an outlet (12) through which the liquid medium flows.

With this configuration, a ceramic heater module in which the thermal efficiency of the ceramic heater is improved can be provided.

A liquid heating device (100) according to the present invention includes a control device (36) configured to control the ceramic heater module (1) according to the present invention.

With this configuration, a liquid heating device in which the thermal efficiency of the ceramic heater is improved can be provided.

A method for manufacturing the ceramic heater (20) according to the present invention includes:
a first step of forming a tubular precursor ceramic body (51p);
a second step of providing a first resistive heating element (62) configured to generate heat when being energized, on at least a part of an inner circumferential surface of the precursor ceramic body (51p); and
a third step of sintering the precursor ceramic body (51p) on which the first resistive heating element (62) has been provided, at a predetermined temperature to produce a ceramic body (51) which has a first opening (O1) through which a medium can flow thereinto, at one end thereof, and a second opening (O2) through which the medium can flow out therefrom, at another end thereof, and in which the first resistive heating element (62) is provided.

With this configuration, a ceramic heater having improved thermal efficiency can be manufactured.

In one aspect of the present invention,
the second step includes
a step of further producing a first green sheet (G1), which is a green sheet of a first ceramic layer (52), such that the first green sheet covers a surface of the first resistive heating element (62), and
a step of providing the first green sheet on at least a part of the inner circumferential surface of the precursor ceramic body, and
the third step includes sintering the precursor ceramic body in which the first green sheet has been further provided, at the predetermined temperature to produce the ceramic body (51) in which the first ceramic layer covering the surface of the first resistive heating element is provided.

With this configuration, since the first green sheet is produced so as to cover the surface of the first resistive heating element in the second step, the durability of the first resistive heating element can be enhanced.

In one aspect of the present invention,
the second step includes a step of further providing a second resistive heating element (63) configured to generate heat when being energized, on at least a part of an outer circumferential surface of the precursor ceramic body (51p), and
the third step includes sintering the precursor ceramic body in which the second resistive heating element has been further provided, at the predetermined temperature to produce the ceramic body (51) in which the second resistive heating element is further provided.

With this configuration, by appropriately setting the connection configuration between the first resistive heating element and the second resistive heating element, a ceramic heater in which thermal efficiency can be improved and the possibility of the medium boiling is significantly reduced when the medium is liquid, can be manufactured.

In one aspect of the present invention,
the second step includes
   a step of further producing a second green sheet (G2), which is a green sheet of a second ceramic layer (53), such that the second green sheet covers a surface of the second resistive heating element (63), and
   a step of providing the second green sheet on at least a part of the outer circumferential surface of the precursor ceramic body, and
the third step includes sintering the precursor ceramic body in which the second green sheet has been further provided, at the predetermined temperature to produce the ceramic body (51) in which the second ceramic layer covering the surface of the second resistive heating element is further provided.

With this configuration, since the second green sheet is produced so as to cover the surface of the second resistive heating element in the second step, the durability of the second resistive heating element can be enhanced.

### BRIEF DESCRIPTION OF THE DRAWINGS

FIG. 1 is a partial cross-sectional schematic diagram of a heating device according to an embodiment.

FIG. 2 is a cross-sectional view of a ceramic base body of a ceramic heater of the heating device in FIG. 1.

FIG. 3 is a perspective view of a cylindrical pre-sintered ceramic body which is a ceramic body before sintering (first step).

FIG. 4 is a perspective view of a first green sheet, which is a green sheet of a first ceramic layer, and a first resistive heating element provided therein (second step).

FIG. 5 is a perspective view of a second green sheet, which is a green sheet of a second ceramic layer, and a second resistive heating element provided therein (second step).

FIG. 6A is a perspective view showing a state where an adhesive is applied to one surface of the first green sheet (second step).

FIG. 6B is a perspective view showing a state where an external force is applied to the first green sheet in FIG. 6A to bend the first green sheet into a cylindrical shape (second step).

FIG. 6C is a diagram illustrating a step of inserting the first green sheet bent into a cylindrical shape into the pre-sintered ceramic body (second step).

FIG. 6D is a diagram illustrating a step of permanently bonding the first green sheet temporarily bonded to the inner circumferential surface of the pre-sintered ceramic body, using a rod member (second step).

FIG. 7 is a diagram illustrating a step of bonding the second green sheet to the outer circumferential surface of the pre-sintered ceramic body (second step).

### MODES FOR CARRYING OUT THE INVENTION

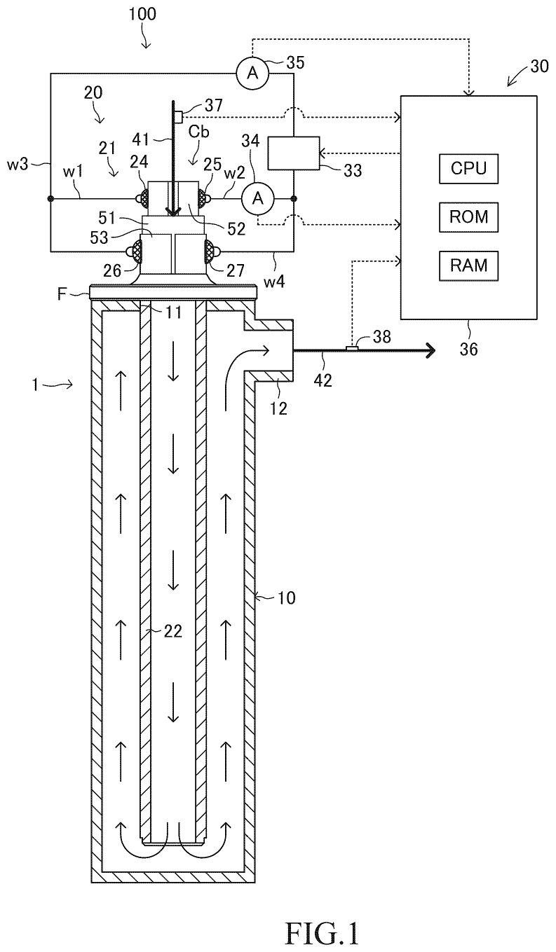

Hereinafter, an embodiment of the present invention will be described with reference to the drawings. FIG. 1 is a schematic configuration diagram of a heating device 100 according to the present embodiment. As shown in FIG. 1, the heating device 100 includes a ceramic heater module 1 and a control unit 30. The heating device 100 is a liquid heating device configured to heat a liquid to a predetermined temperature using the ceramic heater module 1. For the convenience of description, the ceramic heater module 1 is shown in a partial cross-sectional view in FIG. 1. In addition, the ratio of each component in the drawings may differ from the actual ratio.

The ceramic heater module 1 includes a case 10 and a ceramic heater 20. The case 10 is a member for forming a flow path for the liquid to be heated by the ceramic heater 20. The case 10 is formed in a cylindrical shape in which both ends are closed and is shown in FIG. 1 by a cross-section including an axial line. A circular hole 11 is formed in a center portion of an upper end wall of the case 10 so as to extend in an axial direction. In addition, a tubular outlet passage portion 12 is provided in an upper portion of a side peripheral wall of the case 10 in FIG. 1. An outlet pipe 42 is connected to the outlet passage portion 12. Therefore, the internal space of the case 10 communicates with the interior of the outlet pipe 42 via the outlet passage portion 12. The liquid discharged from the case 10 flows into the outlet pipe 42. The circular hole 11 corresponds to an inlet of the case 10, and the outlet passage portion 12 corresponds to an outlet of the case 10.

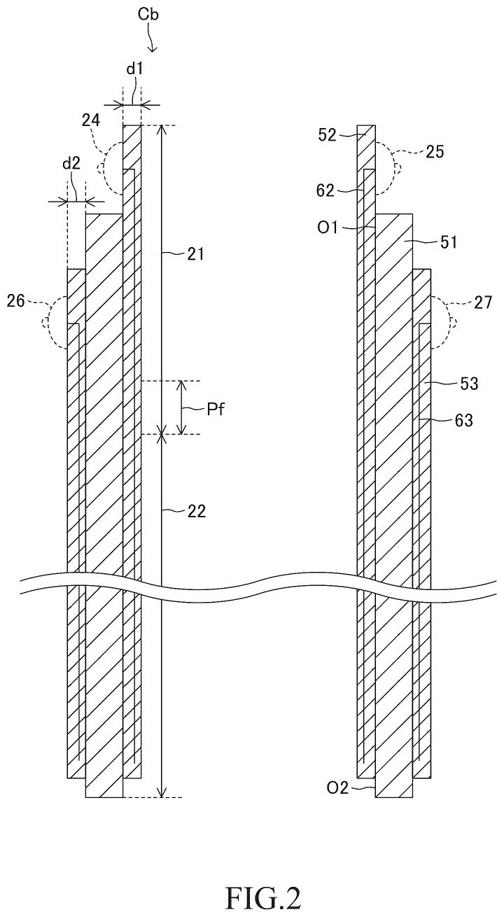

The ceramic heater 20 has resistive heating elements 62 and 63 (see FIG. 2), a substantially cylindrical ceramic base body Cb, and a ring-shaped flange F. The resistive heating elements 62 and 63 are each a member that generates heat when being energized and are each composed of a long conductive wire so as to form a predetermined pattern. An example of each resistive heating element is a tungsten wire. The resistive heating elements 62 and 63 are embedded in the ceramic base body Cb. The ceramic base body Cb is a member for heating an object to be heated and is heated by the resistive heating elements 62 and 63 embedded therein. The ceramic base body Cb is formed of a ceramic material (typically alumina). The flange F is mounted on the outer circumference of a predetermined portion of the ceramic base body Cb so as to extend radially outward.

FIG. 2 is a cross-sectional view of the ceramic base body Cb (strictly speaking, the ceramic base body Cb in which the resistive heating elements 62 and 63 are embedded). As shown in FIG. 1 and FIG. 2, the ceramic base body Cb has a base portion 21 and a main body portion 22. The base portion 21 and the main body portion 22 are provided so as to be connected along the axial direction. The base portion 21 is composed of an upper end portion of the ceramic base body Cb. The main body portion 22 is composed of a cylindrical portion excluding the base portion 21. The base portion 21 has a portion Pf at a lower end portion thereof. The portion Pf is a portion on which the flange F (see FIG. 1) is mounted. The axial length of the main body portion 22 is longer than the axial length of the base portion 21. In addition, the base portion 21 and the main body portion 22 are configured in coaxial cylindrical shapes, and the internal spaces thereof communicate with each other along the axial direction.

As shown in FIG. 2, the ceramic base body Cb is composed of a cylindrical ceramic body 51, a substantially cylindrical ceramic layer 52 (first ceramic layer), and a substantially cylindrical ceramic layer 53 (second ceramic layer). The upper end of the ceramic body 51 is open at an opening O1 (first opening), and the lower end of the ceramic body 51 is open at an opening O2 (second opening). In the present embodiment, the radial thickness of the ceramic body 51 is 2.2 mm but is not limited to this.

The ceramic layer 52 is provided so as to be in contact with the inner circumferential surface of the ceramic body 51, except for an upper end portion thereof. The upper end portion of the ceramic layer 52 protrudes upward (is exposed to the outside) from the upper end of the ceramic body 51. An electrode 24 and an electrode 25 (see broken lines) are formed on the outer circumferential surface of this protruding portion. In other words, the electrodes 24 and 25 are formed on the outer circumferential surface of the base portion 21. The electrodes 24 and 25 are each composed of a conductive member such as a metal. The lower end of the ceramic layer 52 is located slightly above the lower end of the ceramic body 51. The ceramic layer 52 (the outer circumferential surface thereof) and the ceramic body 51 (the inner circumferential surface thereof) are firmly joined at a contact portion therebetween by diffusion bonding.

At a portion in the circumferential direction of the ceramic layer 52, a gap is formed along the axial direction from the upper end to the lower end thereof (see FIG. 1). The length of the gap in the circumferential direction is constant along the axial direction. A radial thickness d1 of the ceramic layer 52 is significantly smaller than the radial thickness of the ceramic body 51, and in the present embodiment, d1=0.55 mm. However, the ceramic layer 52 can be formed so as to have any thickness that satisfies 0.1 mm≤d1≤1.0 mm according to the application of the ceramic heater 20. A reinforcing member having heat resistance may be provided on the portion, of the ceramic layer 52, protruding from the upper end of the ceramic body 51.

The resistive heating element 62 (first resistive heating element) is embedded in the ceramic layer 52. Most of the resistive heating element 62 extends on a virtual circular column surface that is coaxial with the ceramic layer 52. The diameter of this virtual circular column surface is larger than the inner diameter of the ceramic layer 52 and smaller than the outer diameter of the ceramic layer 52. That is, the resistive heating element 62 is embedded relatively inward in the radial direction of the ceramic base body Cb. The resistive heating element 62 is embedded so as to form a predetermined pattern at the main body portion 22. Both end portions of the resistive heating element 62 are extended to the base portion 21, and both ends thereof are respectively connected to the electrodes 24 and 25 formed on the outer circumferential surface of the protruding portion of the ceramic layer 52. Therefore, when a predetermined voltage is applied between the electrode 24 and the electrode 25, the resistive heating element 62 is energized (current flows therethrough).

The ceramic layer 53 is provided so as to be in contact with the outer circumferential surface of the ceramic body 51. The upper end of the ceramic layer 53 is located slightly below the upper end of the ceramic body 51. An electrode 26 and an electrode 27 (see broken lines) are formed on the outer circumferential surface of an upper end portion of the ceramic layer 53. In other words, the electrodes 26 and 27 are formed on the outer circumferential surface of the base portion 21. The electrode 26 and the electrode 27 are each composed of a conductive member such as a metal. The lower end of the ceramic layer 53 is located slightly above the lower end of the ceramic body 51. The ceramic layer 53 (the inner circumferential surface thereof) and the ceramic body 51 (the outer circumferential surface thereof) are firmly joined at a contact portion therebetween by diffusion bonding.

At a portion in the circumferential direction of the ceramic layer 53, a gap is formed along the axial direction from the upper end to the lower end thereof (see FIG. 1). The length of the gap in the circumferential direction is constant along the axial direction. In the present embodiment, a radial thickness d2 of the ceramic layer 53 is equal to the thickness d1 of the ceramic layer 52 (d2=0.55 mm). However, as with the ceramic layer 52, the ceramic layer 53 can be formed so as to have any thickness that satisfies 0.1 mm≤d2≤1.0 mm according to the application of the ceramic heater 20.

The resistive heating element 63 (second resistive heating element) is embedded in the ceramic layer 53. Most of the resistive heating element 63 extends on a virtual circular column surface that is coaxial with the ceramic layer 53. The diameter of this virtual circular column surface is larger than the inner diameter of the ceramic layer 53 and smaller than the outer diameter of the ceramic layer 53. That is, the resistive heating element 63 is embedded relatively outward in the radial direction of the ceramic base body Cb. As with the resistive heating element 62, the resistive heating element 63 is embedded so as to form a predetermined pattern at the main body portion 22. Both end portions of the resistive heating element 63 are extended to the base portion 21, and both ends thereof are respectively connected to the electrodes 26 and 27 formed on the outer circumferential surface of the upper end portion of the ceramic layer 53. Therefore, when a predetermined voltage is applied between the electrode 26 and the electrode 27, the resistive heating element 63 is energized (current flows therethrough).

In the present embodiment, a resistance value R1 of the resistive heating element 62 is equal to a resistance value R2 of the resistive heating element 63 (R1=R2). However, the configuration is not limited to this, and the resistance values R1 and R2 may be different from each other.

Returning to FIG. 1, the description will be continued. An inlet pipe 41 is connected to the base portion 21. Since, as described above, a gap is formed at a portion in the circumferential direction of the protruding portion of the ceramic layer 52, the inlet pipe 41 is inserted up to the upper end of the ceramic body 51. The liquid to be heated by the ceramic heater 20 is introduced from the inlet pipe 41 toward the internal space of the base portion 21.

The axial length of the main body portion 22 is shorter than the axial length of the case 10. In addition, the outer diameter of the main body portion 22 is substantially equal to the diameter of the circular hole 11 formed at the center of the upper end wall of the case 10. The main body portion 22 is inserted into the internal space of the case 10 through the circular hole 11 such that a tip end portion side thereof first enters the internal space. Accordingly, the main body portion 22 is provided coaxially with the case 10 in the internal space of the case 10. At this time, the base portion 21 is exposed upward from the upper end of the case 10, and the flange F is placed on the upper end face of the case 10. The gap between the outer circumference of the upper end of the main body portion 22 and the circular hole 11 is sealed in a liquid-tight manner by a sealing member or the like.

The control unit 30 includes conductive members w1, w2, w3, and w4, a power supply device 33, ammeters 34 and 35, a control device 36, an inlet temperature sensor 37, and an outlet temperature sensor 38.

Each of the conductive members w1 to w4 is composed of a conductive body having one end and another end. An example of the conductive members w1 to w4 is a lead wire. One end of the conductive member w3 is connected to the electrode 26, and the other end of the conductive member w3 is connected to the power supply device 33. One end of the conductive member w4 is connected to the electrode 27, and the other end of the conductive member w4 is connected to the power supply device 33. One end of the conductive member w1 is connected to the electrode 24, and the other end of the conductive member w1 is connected to the conductive member w3. One end of the conductive member w2 is connected to the electrode 25, and the other end of the conductive member w2 is connected to the conductive member w4. That is, the resistive heating element 62 and the resistive heating element 63 are connected in parallel. The power supply device 33 is configured to be able to apply a predetermined voltage between the electrode 24 and the electrode 25 and between the electrode 26 and the electrode 27. The ammeter 34 is provided on the conductive member w2. The ammeter 34 measures a value of current flowing through the conductive member w2. The ammeter 35 is provided on the conductive member w3. The ammeter 35 measures a value of current flowing through the conductive member w3. The ammeters 34 and 35 may be provided on the conductive members w1 and w4, respectively.

The inlet temperature sensor 37 is mounted on the inlet pipe 41 and can detect the temperature of the liquid flowing through the inlet pipe 41. Hereinafter, this temperature is also referred to as “inlet temperature”. The outlet temperature sensor 38 is mounted on the outlet pipe 42 and can detect the temperature of the liquid flowing through the outlet pipe 42. Hereinafter, this temperature is also referred to as “outlet temperature”.

The control device 36 controls the ceramic heater 20. Specifically, the control device 36 controls the energization state (start/stop of energization, power value) of the resistive heating elements 62 and 63 such that the heating temperature of the liquid heated by the ceramic heater 20 becomes a predetermined target temperature. The control device 36 includes a CPU, a ROM, and a RAM.

A program for controlling the energization state of the resistive heating elements 62 and 63 is stored in advance in the ROM of the control device 36. The CPU of the control device 36 reads the program from the ROM, loads the program to the RAM, and executes the program.

The ammeters 34 and 35 transmit current signals representing the measured current values to the control device 36. The control device 36 acquires the current flowing through the conductive member w2, based on the current signal received from the ammeter 34, and acquires the current flowing through the conductive member w3, based on the current signal received from the ammeter 35. In addition, the inlet temperature sensor 37 detects the inlet temperature and transmits a temperature signal representing the detected temperature to the control device 36. The control device 36 acquires the inlet temperature, based on the temperature signal received from the inlet temperature sensor 37. The outlet temperature sensor 38 detects the outlet temperature and transmits a temperature signal representing the detected temperature to the control device 36. The control device 36 acquires the outlet temperature, based on the temperature signal received from the outlet temperature sensor 38. The control device 36 may receive signals other than those described above. The control device 36 is configured to be able to control the power supply device 33, based on various signals (current signals, temperature signals, etc.) inputted thereinto. The energization state of the resistive heating elements 62 and 63 is controlled by the control device 36 controlling the power supply device 33. The power supply device 33 may be incorporated into the control device 36.

In the present embodiment, the heating device 100 configured as described above heats a liquid medium flowing through a flow path within a device installed in a vehicle (hereinafter referred to as “in-vehicle device”). At this time, the ceramic heater 20 functions as a heat exchanger (that is, an in-vehicle heat exchanger) for heating the liquid medium flowing through the flow path within the in-vehicle device. Examples of the in-vehicle device include a vehicle air-conditioning device and a vehicle battery warmer. Examples of the flow path within the in-vehicle device include a flow path in a refrigerant circuit of the vehicle air-conditioning device and a flow path formed in the vehicle battery warmer. In this case, the ceramic heater 20 functions as a heat exchanger for heating a refrigerant flowing in the refrigerant circuit of the vehicle air-conditioning device or a heat exchanger for heating a fluid flowing through the flow path formed in the vehicle battery warmer. Examples of the vehicle include electric vehicles, hybrid vehicles, plug-in hybrid vehicles, and fuel cell vehicles.

In the heating device 100 configured as described above, the liquid as the object to be heated is introduced from the inlet pipe 41 into the interior of the base portion 21 of the ceramic heater 20 and further introduced from the base portion 21 into the internal space of the main body portion 22.

The liquid that has been introduced into the internal space of the main body portion 22 flows from the top to the bottom inside the main body portion 22 and flows out from the opening at the tip (lower end) of the main body portion 22 as shown by arrows in FIG. 1. The liquid that has flowed out from the main body portion 22 flows upward as shown by arrows in FIG. 1 in the space between the inner circumferential surface of the side peripheral wall of the case 10 and the outer circumferential surface of the main body portion 22 and is discharged to the outlet pipe 42 via the outlet passage portion 12. As described above, the flow path for the liquid to a location where the liquid introduced (supplied) from the inlet pipe 41 is discharged to the outlet pipe 42 is formed by the case 10.

When the liquid is flowing inside the case 10, the control device 36 controls the power supply device 33 such that a predetermined voltage is applied between the electrode 24 and the electrode 25 and between the electrode 26 and the electrode 27. Accordingly, the resistive heating elements 62 and 63 are energized. The resistive heating elements 62 and 63 generate heat when being energized. The main body portion 22 is heated by the heat generated by the resistive heating elements 62 and 63. More specifically, the inner circumferential surface of the main body portion 22 is mainly heated by the heat generated by the resistive heating element 62, and the outer circumferential surface of the main body portion 22 is mainly heated by the heat generated by the resistive heating element 63. Accordingly, the liquid flowing on the surface (inner circumferential surface and outer circumferential surface) of the heated main body portion 22 is heated by the main body portion 22. Thus, the liquid is heated by the heating device 100 (ceramic heater 20), and the heated liquid is discharged to the outlet pipe 42.

The control device 36 acquires the temperature of the liquid before being heated by the heating device 100, as the inlet temperature, based on the temperature signal transmitted from the inlet temperature sensor 37 which is mounted on the inlet pipe 41. In addition, the control device 36 acquires the temperature of the liquid after being heated by the heating device 100, as the outlet temperature, based on the temperature signal transmitted from the outlet temperature sensor 38 which is mounted on the outlet pipe 42. The control device 36 then controls the power supply device 33 such that the outlet temperature matches the target temperature. Accordingly, the temperature of the liquid can be controlled such that the temperature of the liquid discharged to the outlet pipe 42 becomes a predetermined target temperature. In this case, the control device 36 can control the temperature of the liquid such that the outlet temperature approaches the target temperature, through PI control based on the deviation between the outlet temperature and the target temperature.

When the heating device 100 is operating normally, the entire surface of the main body portion 22 is brought into contact with the liquid introduced into the heating device 100. Therefore, the main body portion 22 is heated by the resistive heating elements 62 and 63 and also cooled by the liquid flowing on the surface of the main body portion 22. Therefore, the surface temperature of the main body portion 22 sharply rises immediately after the start of energization of the resistive heating elements 62 and 63, but soon, the surface temperature gradually approaches a temperature at which a balance between heating and cooling is achieved, and is eventually maintained at a nearly constant temperature. Then, the liquid is heated by the main body portion 22 whose surface temperature is maintained at a nearly constant temperature.

Next, a method for manufacturing the ceramic heater 20 will be described. This manufacturing method includes a pre-sintered ceramic body production step, a green sheet production step, a green sheet bonding step, a sintering step, and a flange mounting step. The ceramic heater 20 is manufactured by these steps being carried out in this order.

### (Pre-Sintered Ceramic Body Production Step)

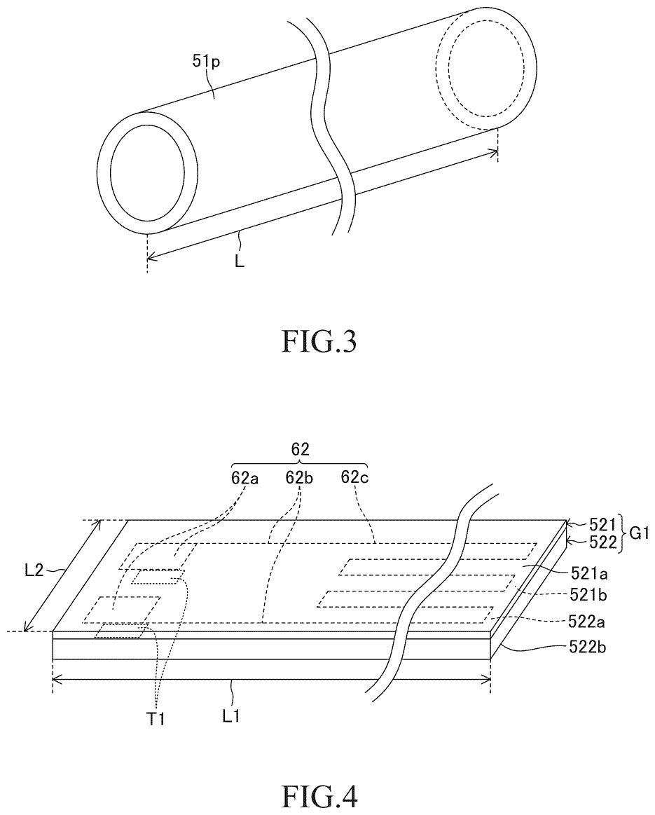

In this step, a pre-sintered ceramic body 51p (precursor ceramic body) shown in FIG. 3 is produced. Specifically, a material mainly containing alumina is compounded, and a cylindrical member is produced by extrusion molding. Then, the cylindrical member is dried by rolling, cut to a predetermined length, and preliminarily sintered at a temperature of 700 to 800° C. Accordingly, a binder, etc., within the cylindrical member are degreased and the rigidity of the cylindrical member is improved. Substantially, both ends of the cylindrical member are cut such that the axial length of the cylindrical member becomes L, and chamfering is performed as appropriate on the cylindrical member to produce the pre-sintered ceramic body 51p. One end of the pre-sintered ceramic body 51p is open at the opening O1, and the other end of the pre-sintered ceramic body 51p is open at the opening O2. This step corresponds to an example of a “first step”.

### (Green Sheet Production Step)

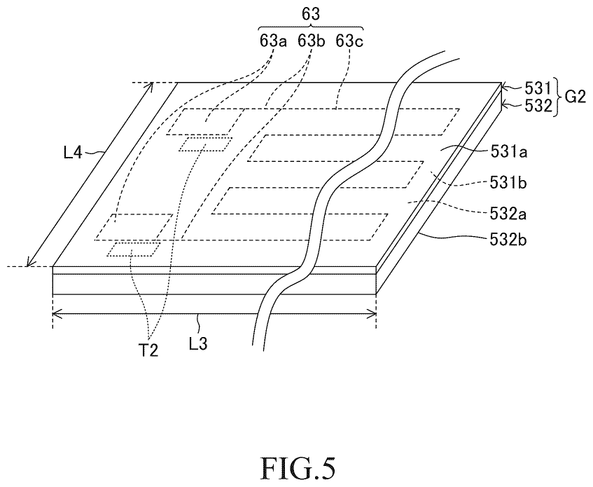

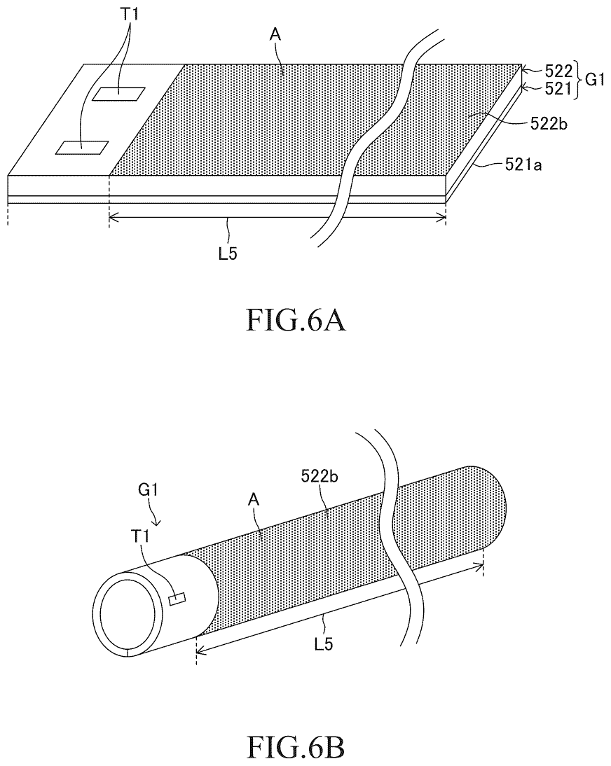

In this step, a green sheet G1 shown in FIG. 4 and a green sheet G2 shown in FIG. 5 are produced. In the following, the green sheets G1 and G2 will be sequentially described. As shown in FIG. 4, the green sheet G1 is configured to include a green sheet 521 and a green sheet 522. The procedure for producing the green sheet G1 is as follows. First, a material mainly containing alumina is compounded to prepare a slurry, and the green sheet 521 having a thickness of 0.05 mm and the green sheet 522 having a thickness of 0.59 mm are produced using a doctor blade method. The green sheets 521 and 522 are produced so as to have the same size and shape in a plan view.

Next, the resistive heating element 62 (shown by a broken line in FIG. 4) is pattern-printed on one surface 522a of the green sheet 522, and two conductive terminal portions T1 are pattern-printed on another surface 522b of the green sheet 522. The resistive heating element 62 is configured to include two terminal connection portions 62a, two extension portions 62b, and one heater portion 62c. The two terminal connection portions 62a each have a quadrangular shape and are spaced apart along the transverse direction of the green sheet 522. The two terminal portions T1 each have a quadrangular shape smaller than the terminal connection portion 62a and are spaced apart along the transverse direction. In a plan view, the centers of the two terminal connection portions 62a substantially coincide with the centers of the two terminal portions T1. A through hole which is not shown is formed in advance at locations substantially the center of each terminal connection portion 62a in the green sheet 522 by punching. In performing the above pattern-printing, the resistive heating element 62 is also printed on the inner circumferential surface of this through hole. Accordingly, each terminal connection portion 62a and each terminal portion T1 are electrically connected through the through hole.

The two extension portions 62b are linear and extend along the longitudinal direction of the green sheet 522. One of the extension portions 62b connects one of the terminal connection portions 62a and the heater portion 62c, and the other of the extension portions 62b connects the other of the terminal connection portions 62a and the heater portion 62c. The terminal connection portions 62a and the extension portions 62b are formed in a region corresponding to the base portion 21 after the ceramic heater 20 is completed.

The heater portion 62c occupies most of the resistive heating element 62. The resistance value R1 of the resistive heating element 62 can be determined by the pattern (thickness and length of a printed metal wire) of the heater portion 62c. The heater portion 62c is formed in a region corresponding to the main body portion 22 after the ceramic heater 20 is completed.

In parallel, two sets of pads which are not shown are pattern-printed on one surface 521b of the green sheet 521. The two sets of pads are arranged at positions overlapping the through holes in a plan view when the green sheets 521 and 522 are stacked in the thickness direction. Then, the green sheet 521 is placed on the green sheet 522 such that the surface 521b is in contact with the surface 522a, and thermal bonding is performed thereon using a rubber press. Thus, the green sheet G1 (strictly speaking, the green sheet G1 in which the resistive heating element 62 is embedded) is produced. The green sheet G1 is a thin, flat plate-like member and has flexibility. The green sheet G1 is produced such that a length L1 in the longitudinal direction thereof is longer than the axial length L of the pre-sintered ceramic body 51p (see FIG. 3) (L1>L) and a length L2 in the transverse direction thereof is shorter than the inner circumference of the pre-sintered ceramic body 51p.

Next, the green sheet G2 will be described. As shown in FIG. 5, the green sheet G2 is configured to include a green sheet 531 and a green sheet 532. The procedure for producing the green sheet G2 is substantially the same as the procedure for producing the green sheet G1, and thus the redundant description is omitted. The green sheets 531 and 532 are produced by the doctor blade method using the same slurry as for the green sheets 521 and 522. However, the slurry for the green sheets 531 and 532 may be prepared with a formulation different from that of the slurry for the green sheets 521 and 522. The thickness of the green sheet 531 is equal to the thickness of the green sheet 521 (i.e., 0.05 mm), and the thickness of the green sheet 532 is equal to the thickness of the green sheet 522 (i.e., 0.59 mm). The green sheets 531 and 532 are produced so as to have the same size and shape in a plan view.

Next, the resistive heating element 63 (shown by a broken line in FIG. 5) is pattern-printed on one surface 532a of the green sheet 532, and two conductive terminal portions T2 are pattern-printed on another surface 532b of the green sheet 532. The resistive heating element 63 is configured to include two terminal connection portions 63a, two extension portions 63b, and one heater portion 63c. The pattern of the resistive heating element 63 is similar to the pattern of the resistive heating element 62. Each terminal connection portion 63a and each terminal portion T2 are electrically connected via a through hole formed at locations substantially the center of the terminal connection portion 63a. The heater portion 63c occupies most of the resistive heating element 63, and the resistance value R2 of the resistive heating element 63 can be determined by the pattern of the heater portion 63c. One of the extension portions 63b connects one of the terminal connection portions 63a and the heater portion 63c, and the other of the extension portions 63b connects the other of the terminal connection portions 63a and the heater portion 63c. The terminal connection portions 63a and the extension portions 63b are formed in a region corresponding to the base portion 21 after the ceramic heater 20 is completed, and the heater portion 63c is formed in a region corresponding to the main body portion 22 after the ceramic heater 20 is completed.

In parallel, two sets of pads which are not shown are pattern-printed on one surface 531b of the green sheet 531. Then, the green sheets 531 and 532 are thermally bonded using a rubber press such that the surface 531b and the surface 532a are in contact with each other. Thus, the green sheet G2 (strictly speaking, the green sheet G2 in which the resistive heating element 63 is embedded) is produced. The green sheet G2 is a thin, flat plate-like member and has flexibility. The green sheet G2 is produced such that a length L3 in the longitudinal direction thereof is shorter than the axial length L of the pre-sintered ceramic body 51p (see FIG. 3) (L3<L) and a length L4 in the transverse direction thereof is shorter than the outer circumference of the pre-sintered ceramic body 51p.

### (Green Sheet Bonding Step)

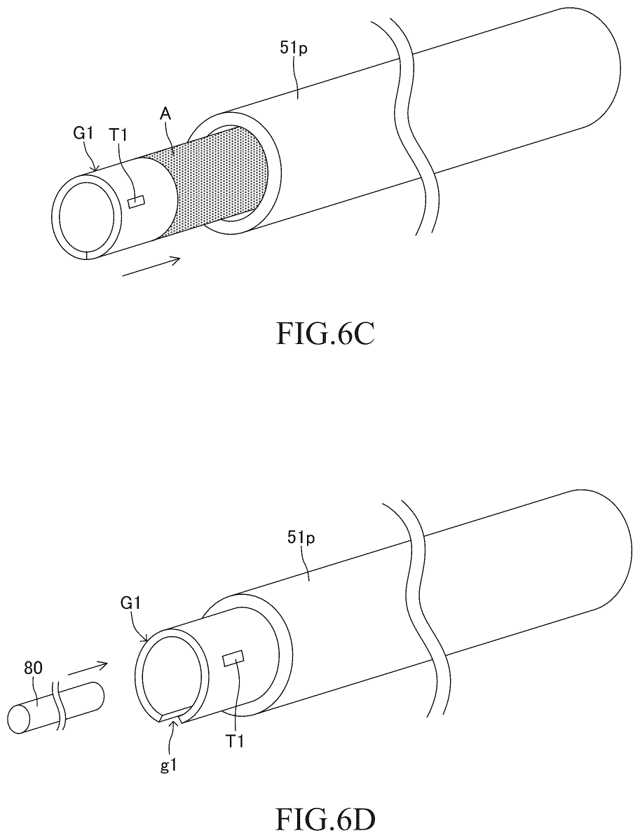

In this step, the green sheets G1 and G2 are bonded to the pre-sintered ceramic body 51p. Specifically, first, as shown in FIG. 6A, the green sheet G1 is placed such that a surface 521a thereof (the other surface of the green sheet 521) faces downward, and an adhesive A (shown in gray in FIG. 6A) is applied to a part of the surface 522b by screen printing. The adhesive A is applied to the entire region from one end in the longitudinal direction (end on the side opposite to the side where the terminal portions T1 are formed) to a position spaced therefrom by a length L5 in the longitudinal direction. That is, the adhesive A is not applied to a region where the terminal portions T1 are formed. The length L5 is slightly shorter than the axial length L of the pre-sintered ceramic body 51p (L5<L).

Next, as shown in FIG. 6B, an external force is applied to the green sheet G1 by an external device, which is not shown, to bend the green sheet G1 into a cylindrical shape. The green sheet G1 is bent such that the surface 522b becomes an outer circumferential surface and the longitudinal direction thereof coincides with the axial direction. This operation may be performed manually.

Subsequently, as shown in FIG. 6C, the green sheet G1 bent into a cylindrical shape is inserted into the through hole of the pre-sintered ceramic body 51p by a predetermined length in a state where the shape of the green sheet G1 is maintained by the external device. In the present embodiment, the cylindrical green sheet G1 is inserted such that the end thereof on the side opposite to the side where the terminal portions T1 are formed enters first, but the insertion direction thereof is not limited to this. The cylindrical green sheet G1 is inserted into the through hole of the pre-sintered ceramic body 51p while a coaxial state therebetween is being maintained. Since the outer circumference of the cylindrical green sheet G1 is L2 and is shorter than the inner circumference of the pre-sintered ceramic body 51p, inserting the cylindrical green sheet G1 as described above prevents the adhesive A from adhering to the inner circumferential surface of the pre-sintered ceramic body 51p. Since the axial length L5 of the portion, of the cylindrical green sheet G1, to which the adhesive A has been applied is shorter than the axial length L of the pre-sintered ceramic body 51p, the adhesive A is not exposed to the outside after the insertion is completed. The insertion operation may be performed manually.

Then, as shown in FIG. 6D, the external force applied to the cylindrical green sheet G1 is released. As a result, the cylindrical green sheet G1 tends to return to its original shape due to the reaction force, and in this process, the outer circumferential surface of the cylindrical green sheet G1 comes into contact with the inner circumferential surface of the pre-sintered ceramic body 51p. Accordingly, the substantially cylindrical green sheet G1 (the outer circumferential surface thereof) is temporarily bonded to the pre-sintered ceramic body 51p (the inner circumferential surface thereof) by the adhesive A. Subsequently, a rod member 80 is inserted into the through hole and is rotated while a force directed radially outward is being applied to the inner circumferential surface of the green sheet G1, thereby permanently bonding the temporarily bonded green sheet G1 to the pre-sintered ceramic body 51p. This operation may be performed manually.

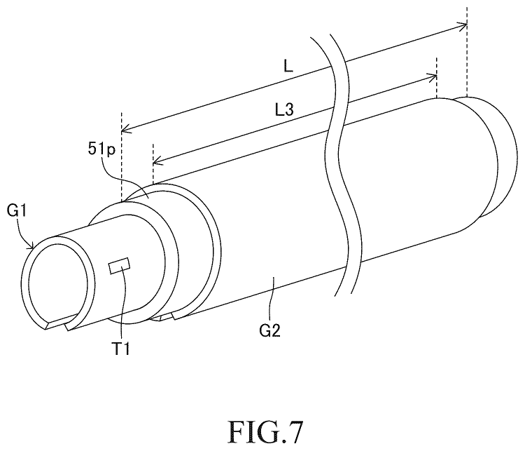

Then, the adhesive A is applied to the entirety of a surface 531a of the green sheet G2 (the other surface of the green sheet 531: see FIG. 5) by screen printing, and the pre-sintered ceramic body 51p to which the green sheet G1 has been bonded is caused to make substantially one rotation on the surface 531a (not shown). Accordingly, as shown in FIG. 7, the substantially cylindrical green sheet G2 (the inner circumferential surface thereof) is bonded to the pre-sintered ceramic body 51p (the outer circumferential surface thereof). Since the axial length L3 of the substantially cylindrical green sheet G2 is shorter than the axial length L of the pre-sintered ceramic body 51p, both end portions of the pre-sintered ceramic body 51p are slightly exposed from the substantially cylindrical green sheet G2.

The green sheet production step and the green sheet bonding step correspond to an example of a “second step”.

### (Sintering Step)

In this step, the pre-sintered ceramic body 51p to which the green sheets G1 and G2 have been bonded is sintered at a temperature of 1300 to 1500° C. Accordingly, the pre-sintered ceramic body 51p and the green sheets G1 and G2 become the ceramic body 51 and the ceramic layers 52 and 53, respectively. The contact surfaces between the ceramic body 51 and the ceramic layers 52 and 53 are firmly joined by diffusion bonding. Thus, the ceramic base body Cb in which the resistive heating elements 62 and 63 are embedded is produced. The sintering step corresponds to an example of a “third step”.

### (Flange Mounting Step)

In this step, the ring-shaped flange F (see FIG. 1) is mounted on the portion Pf of the ceramic base body Cb. Specifically, first, the flange F is prepared, the ceramic base body Cb is inserted into the through hole of the flange F, and the flange F is fixed at the position of the portion Pf, whereby the mounting is performed. Through the above steps, the ceramic heater 20 shown in FIG. 1 and FIG. 2 is manufactured.

As described above, in the ceramic heater 20 according to the present embodiment, the resistive heating element 62 is provided relatively inward in the radial direction of the ceramic base body Cb. With this configuration, the heat generated in the resistive heating element 62 is more easily conducted to the inner circumferential surface of the ceramic base body Cb than to the outer circumferential surface of the ceramic base body Cb. Therefore, from the viewpoint of temperature rise of the liquid by the resistive heating element 62, the liquid is more easily heated during the period when the liquid flows on the inner circumferential surface of the ceramic base body Cb (main body portion 22) than during the period when the liquid flows on the outer circumferential surface of the ceramic base body Cb (main body portion 22). Here, in general, in a tubular heating element, the thermal efficiency for heating a medium flowing on the inner circumferential surface of the heating element is higher than the thermal efficiency for heating the medium flowing on the outer circumferential surface of the heating element. Therefore, the ceramic heater 20 can improve thermal efficiency compared to a conventional ceramic heater (i.e., a ceramic heater in which a resistive heating element is only provided relatively outward in the radial direction of the ceramic base body Cb).

In particular, in the ceramic heater 20 according to the present embodiment, the resistive heating element 63 is further provided relatively outward in the radial direction of the ceramic base body Cb, and the resistive heating elements 62 and 63 are connected in parallel with each other. If a conventional ceramic heater in which a resistive heating element having a resistance value equal to the combined resistance value of the resistive heating elements 62 and 63 is only provided relatively outward in the radial direction of the ceramic base body Cb is defined as a ceramic heater P, when the same voltage is applied to the ceramic heater 20 and the ceramic heater P, the power in each of the resistive heating elements 62 and 63 is one-half of the power in the resistive heating element of the ceramic heater P. With this configuration, the ceramic heater 20 can lower the power density (energy density per unit time) of the ceramic base body Cb compared to the ceramic heater P, thereby improving the thermal efficiency of the liquid and also significantly reducing the possibility of the liquid boiling, resulting in suppressing the occurrence of ceramic heater breakage due to boiling.

Furthermore, when the radial thickness of the ceramic layer 52 is set to 0.1 mm or more, the strength of the ceramic layer 52 can be ensured. Also, when the radial thickness of the ceramic layer 52 is set to 1.0 mm or less, the conductivity of the heat generated in the resistive heating element 62 can be suitably maintained. Similarly, when the radial thickness of the ceramic layer 53 is set to 0.1 mm or more, the strength of the ceramic layer 53 can be ensured. Also, when the radial thickness of the ceramic layer 53 is set to 1.0 mm or less, the conductivity of the heat generated in the resistive heating element 63 can be suitably maintained.

Although the embodiment of the present invention has been described above, the present invention is not limited to the above embodiment, and various modifications can be made without departing from the scope of the present invention.

Furthermore, the present disclosure may include the following aspects.

A ceramic heater comprising:
a tubular ceramic body having a first opening through which a medium can flow thereinto, at one end thereof, and a second opening through which the medium can flow out therefrom, at another end thereof; and
a first resistive heating element provided on at least a part of an inner circumferential surface of the ceramic body and configured to generate heat when being energized.

The ceramic heater according to [1], further comprising a first ceramic layer covering a surface of the first resistive heating element.

The ceramic heater according to [1] or [2], further comprising a second resistive heating element provided on at least a part of an outer circumferential surface of the ceramic body and configured to generate heat when being energized.

The ceramic heater according to [3], further comprising a second ceramic layer covering a surface of the second resistive heating element.

The ceramic heater according to [2], wherein the first ceramic layer has a radial thickness of 0.1 mm or more and 1.0 mm or less.

The ceramic heater according to [4], wherein the second ceramic layer has a radial thickness of 0.1 mm or more and 1.0 mm or less.

The ceramic heater according to any one of [1] to [6], wherein
the medium is a liquid medium, and
the ceramic heater is used as an in-vehicle heat exchanger.

A ceramic heater module comprising:
the ceramic heater according to any one of [1] to [7]; and
a case housing the ceramic heater therein and having an inlet and an outlet through which the liquid medium flows.

A liquid heating device comprising a control device configured to control the ceramic heater module according to [8].

A method for manufacturing a ceramic heater, the method comprising:
a first step of forming a tubular precursor ceramic body;
a second step of providing a first resistive heating element configured to generate heat when being energized, on at least a part of an inner circumferential surface of the precursor ceramic body; and
a third step of sintering the precursor ceramic body on which the first resistive heating element has been provided, at a predetermined temperature to produce a ceramic body which has a first opening through which a medium can flow thereinto, at one end thereof, and a second opening through which the medium can flow out therefrom, at another end thereof, and in which the first resistive heating element is provided.

The method for manufacturing a ceramic heater according to [10], wherein the second step includes
a step of further producing a first green sheet, which is a green sheet of a first ceramic layer, such that the first green sheet covers a surface of the first resistive heating element, and
a step of providing the first green sheet on at least a part of the inner circumferential surface of the precursor ceramic body, and
the third step includes sintering the precursor ceramic body in which the first green sheet has been further provided, at the predetermined temperature to produce the ceramic body in which the first ceramic layer covering the surface of the first resistive heating element is provided.

The method for manufacturing a ceramic heater according to [10] or [11], wherein
the second step includes a step of further providing a second resistive heating element configured to generate heat when being energized, on at least a part of an outer circumferential surface of the precursor ceramic body, and
the third step includes sintering the precursor ceramic body in which the second resistive heating element has been further provided, at the predetermined temperature to produce the ceramic body in which the second resistive heating element is further provided.

The method for manufacturing a ceramic heater according to [12], wherein the second step includes
a step of further producing a second green sheet, which is a green sheet of a second ceramic layer, such that the second green sheet covers a surface of the second resistive heating element, and
a step of providing the second green sheet on at least a part of the outer circumferential surface of the precursor ceramic body, and
the third step includes sintering the precursor ceramic body in which the second green sheet has been further provided, at the predetermined temperature to produce the ceramic body in which the second ceramic layer covering the surface of the second resistive heating element is further provided.

### DESCRIPTION OF REFERENCE NUMERALS

1: ceramic heater module
10: case
11: circular hole
12: outlet passage portion
20: ceramic heater
21: base portion
22: main body portion
24, 25, 26, 27: electrode
30: control unit
33: power supply device
34, 35: ammeter
36: control device
37: inlet temperature sensor
38: outlet temperature sensor
41: inlet pipe
42: outlet pipe
51: ceramic body
51p: precursor ceramic body
52, 53: ceramic layer
62, 63: resistive heating element
100: heating device

1. A ceramic heater comprising:
a tubular ceramic body having a first opening through which a medium can flow thereinto, at one end thereof, and a second opening through which the medium can flow out therefrom, at another end thereof; and
a first resistive heating element provided on at least a part of an inner circumferential surface of the ceramic body and configured to generate heat when being energized.

2. The ceramic heater according to claim 1, further comprising a first ceramic layer covering a surface of the first resistive heating element.

3. The ceramic heater according to claim 1, further comprising a second resistive heating element provided on at least a part of an outer circumferential surface of the ceramic body and configured to generate heat when being energized.

4. The ceramic heater according to claim 3, further comprising a second ceramic layer covering a surface of the second resistive heating element.

5. The ceramic heater according to claim 2, wherein the first ceramic layer has a radial thickness of 0.1 mm or more and 1.0 mm or less.

6. The ceramic heater according to claim 4, wherein the second ceramic layer has a radial thickness of 0.1 mm or more and 1.0 mm or less.

7. The ceramic heater according to claim 1, wherein
the medium is a liquid medium, and
the ceramic heater is used as an in-vehicle heat exchanger.

8. A ceramic heater module comprising:
the ceramic heater according to claim 7; and
a case housing the ceramic heater therein and having an inlet and an outlet through which the liquid medium flows.

9. A liquid heating device comprising a control device configured to control the ceramic heater module according to claim 8.

10. A method for manufacturing a ceramic heater, the method comprising:
a first step of forming a tubular precursor ceramic body;
a second step of providing a first resistive heating element configured to generate heat when being energized, on at least a part of an inner circumferential surface of the precursor ceramic body; and
a third step of sintering the precursor ceramic body on which the first resistive heating element has been provided, at a predetermined temperature to produce a ceramic body which has a first opening through which a medium can flow thereinto, at one end thereof, and a second opening through which the medium can flow out therefrom, at another end thereof, and in which the first resistive heating element is provided.

11. The method for manufacturing a ceramic heater according to claim 10, wherein the second step includes
a step of further producing a first green sheet, which is a green sheet of a first ceramic layer, such that the first green sheet covers a surface of the first resistive heating element, and
a step of providing the first green sheet on at least a part of the inner circumferential surface of the precursor ceramic body, and
the third step includes sintering the precursor ceramic body in which the first green sheet has been further provided, at the predetermined temperature to produce the ceramic body in which the first ceramic layer covering the surface of the first resistive heating element is provided.

12. The method for manufacturing a ceramic heater according to claim 10, wherein
the second step includes a step of further providing a second resistive heating element configured to generate heat when being energized, on at least a part of an outer circumferential surface of the precursor ceramic body, and
the third step includes sintering the precursor ceramic body in which the second resistive heating element has been further provided, at the predetermined temperature to produce the ceramic body in which the second resistive heating element is further provided.

13. The method for manufacturing a ceramic heater according to claim 12, wherein the second step includes
a step of further producing a second green sheet, which is a green sheet of a second ceramic layer, such that the second green sheet covers a surface of the second resistive heating element, and
a step of providing the second green sheet on at least a part of the outer circumferential surface of the precursor ceramic body, and
the third step includes sintering the precursor ceramic body in which the second green sheet has been further provided, at the predetermined temperature to produce the ceramic body in which the second ceramic layer covering the surface of the second resistive heating element is further provided.
